(19) United States
(12) Patent Application Publication
(10) Pub. No.: US 2006/0098405 A1
(43) Pub. Date: May 11, 2006

(54) Combined mass storage and subscriber identity module and apparatus for use therewith

(76) Inventor: Leland Scott Bloebaum, Cary, NC (US)

Correspondence Address: MYERS BIGEL SIBLEY & SAJOVEC, P.A., P.O. BOX 37428, RALEIGH, NC, 27627, US

(21) Appl. No.: 10/983,800

(22) Filed: Nov. 8, 2004

(51) Int. Cl. G06F 1/16

(52) U.S. Cl. 361/685

(57) ABSTRACT

A mass storage and subscriber identity module includes a frame. A mass storage device, such as a magnetic disk drive, optical disk drive and/or nonvolatile integrated circuit memory, is supported by the frame. A first connector is supported by the frame and configured to be connected to a smart card, such as a GSM SIM card. A second connector is supported by the frame, electrically coupled to the mass storage device and the first connector, and configured to be removably connected to an electronic device, such as a wireless handset, PDA or other portable electronic device.

### BACKGROUND OF THE INVENTION

The present invention relates to electronic devices and accessories therefor, and more particularly, to peripheral modules for use with electronic devices, such as wireless handsets, personal digital assistants, gaming devices, and laptop computers.

Consumer electronics devices, such as laptop computers, notebook computers, pocket PCs, personal digital assistants (PDAs), gaming devices, and the like, now commonly possess wireless communications capabilities. For example, many laptop and notebook computers now incorporate radio communications circuitry configured to communicate with, for example, wireless local area (e.g., WiFi) networks. Devices, such as PDAs and laptops, may also be configured, e.g., through use of special-purpose cards, to communicate with public cellular (e.g., GSM or IS-95 CDMA) networks. An example of a GSM-compatible wireless card for use with a laptop computer is the GC-82 cellular PC card produced by SonyEricsson Mobile Communications AB.

Some portable electronic devices now use mass storage devices to hold large amounts of data, such as video and music files. For example, some portable music players, such as the iPod®, include an internal hard disk drive (HDD), and a wireless phone with an HDD has been recently introduced by Samsung Electronics. Advanced mobile phones and other wireless devices (e.g., wireless PDAs) are increasingly incorporating significant digital media capabilities, e.g., digital still cameras, video recorders, audio recorders, etc., so it is likely that mass storage capability will become even more desirable. It is known to connectorize small HDDs, such as those used in portable music players, so that they can be removed and plugged into compatible connectors on other devices, e.g., a mass storage reader on a desktop or laptop computer. This can allow for transfer of data (e.g., MP3 files) to or from the HDD. This portability also can allow a user to migrate content between devices, e.g., between a portable music player and home stereo system.

### SUMMARY OF THE INVENTION

In some embodiments of the present invention, a mass storage and subscriber identity module includes a frame. A mass storage device, such as one including a magnetic storage medium (e.g., hard disk drive), optical storage medium (e.g., optical disk) and/or semiconductor storage medium (e.g., integrated circuit memory), is supported by the frame. A first connector is supported by the frame and configured to be connected to a smart card, such as a GSM SIM card. A second connector is supported by the frame, electrically coupled to the mass storage device and the first connector, and configured to be removably connected to an electronic device. Smart card contacts of the first connector may be directly connected to contacts of the second connector and/or the module may include interface circuitry supported by the frame and configured to support communications between the first and second connectors. The first connector may include means, e.g., a clip, sleeve or other retaining structure, for mechanically attaching the smart card to the frame

In further embodiments of the present invention, the module's frame includes a housing. The mass storage device is positioned within the housing, and the first connector is positioned at a surface of the housing. The first connector may include a plurality of electrical contacts positioned on the surface of the housing and a clip configured to hold the smart card against the surface of the housing such that electrical contacts of the smart card are held in contact with the electrical contacts of the first connector. The housing may include opposing first and second major sides and an edge side disposed between the first and second major sides, the first connector may be positioned at the first major side, and the second connector may be positioned at the edge side. The first connector may include a plurality of electrical contacts positioned on the first major side of the housing and a clip configured to hold the smart card against the first side of the housing such that electrical contacts of the SIM are held in contact with the electrical contacts of the first connector.

According to further embodiments of the present invention, an apparatus includes mass storage and subscriber identity module removably connectable to an electronic device. The mass storage and subscriber identity module may include a magnetic storage medium, an optical storage medium and/or a semiconductor storage medium. The mass storage and subscriber identity module may further include a smart card connector configured to be connected to a smart card, e.g., a GSM SIM card. The mass storage and subscriber identity module may include a housing that contains the disk drive and/or nonvolatile integrated circuit memory, and the smart card connector may include means for removably attaching a smart card to the housing. The smart card connector may include a plurality of contacts disposed on a side of the housing and means for holding a smart card against the side of the housing such that contacts of the smart card are held in electrical contact with the plurality of contacts disposed on the side of the housing.

In still further embodiments of the present invention, an apparatus includes an electronic device configured to be removably connected to a mass storage and subscriber identity module. The electronic device may include interface circuitry configured to communicate with mass storage and a smart card of the mass storage and subscriber identity module. The electronic device may include a connector configured to removably connect the mass storage and subscriber identity module to the electronic device. The electronic device may include a housing and means for removably attaching the mass storage and subscriber identity module to the housing. The means for removably attaching may include a bay or slot configured to receive a housing of the mass storage and subscriber identity module.

### BRIEF DESCRIPTION OF THE DRAWINGS

FIG. 1 illustrates removable mass storage and subscriber identity module employed with a wireless handset according to some embodiments of the present invention.

FIGS. 2 and 3 illustrate the removable mass storage and subscriber identity module of FIG. 1 with and without a smart card installed, respectively.

FIG. 4 is a block diagram illustrating a mass storage and subscriber identity module according to further embodiments of the present invention.

FIG. 5 is a block diagram illustrating an electronic device configured for use with a mass storage and subscriber identity module according to some embodiments of the present invention.

FIGS. 6 and 7 illustrate the removable mass storage and subscriber identity module of FIG. 1 employed with a PDA and a laptop computer, respectively, according to further embodiments of the present invention.

### DETAILED DESCRIPTION OF EXEMPLARY EMBODIMENTS

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular exemplary embodiments illustrated in the accompanying drawings is not intended to be limiting of the invention. In the drawings, like numbers refer to like elements.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Some embodiments of the present invention arise from a realization that performance for wireless devices, such as wireless handsets and wireless-enabled PDAs and computers, may be enhanced by combining portable mass storage, such as may be provided with a connectorized HDD, with subscriber identity functionality that is typically desired for the wireless environment. In some embodiments of the present invention, this enhanced capability can be provided by a mass storage and subscriber identity module that is configured to be removably connected to an electronic device, such as a wireless handset or wireless-enabled computer. Subscriber identity capability may be integrated into such a module or, according to additional aspects of the present invention, subscriber identity functions may be provided by a mass storage and subscriber identity module that is configured to be connected to a smart card (e.g., a GSM SIM card) that performs subscriber identity functions.

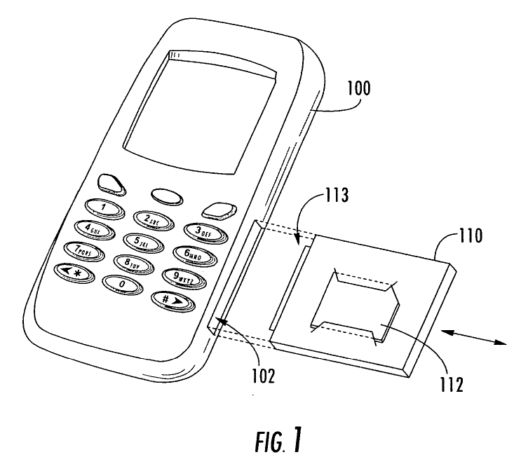

Referring to FIG. 1, in some embodiments of the present invention, an electronic device, in particular, a wireless handset 100, may be configured to connect to a removable mass storage and subscriber identity module 110 that performs mass storage and subscriber identity functions. In the illustrated embodiments, the module 110 is configured to connect to a smart card 112, e.g., a GSM SIM card, that is configured to support the subscriber identity function performed by the module 110. As shown, the module 110 is configured for insertion in a bay (slot) 102, such that a connector 113 of the module 110 engages a mating connector (not shown) within the handset 100. Although the smart card 112 is shown as being retained in a clip-like assembly on the module 110, it will be appreciated that, in various embodiments of the present invention, a mass storage and subscriber identity module could be configured to receive a smart card in a slot, opening, or other retaining structure that facilitates electrical connection and mechanical attachment of the smart card to the module.

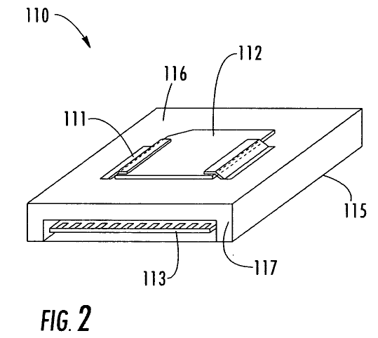

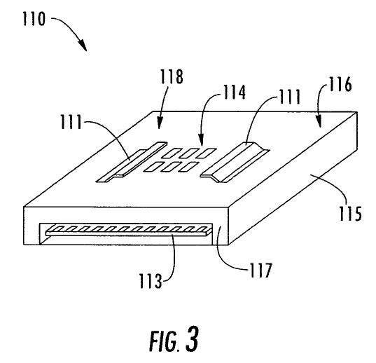

FIGS. 2-3 are views that illustrate additional features of the mass storage and subscriber identity module 110, with and without installation of the smart card 112. The module 110 includes a frame, in particular, a housing 115, that supports a mass storage device, such as one including a magnetic storage medium (e.g., an HDD), an optical storage medium (e.g., an optical disk drive) and/or a semiconductor storage medium (e.g., flash memory). The housing 115 also supports a card edge connector 113 that is disposed at an edge side 117 of the housing 115 and that is configured to mate with a matching connector in an electronic device, such as the handset 100 of FIG. 1. The housing 115 further supports a second connector 118, here shown as including a plurality of contacts 114 disposed on a major side 116 of the housing 115 and a clip or sleeve 111 that is configured to electrically connect to and retain the smart card 112. In particular, the clip 111 is configured to hold the smart card 112 against the major side 116 of the housing 115 such that the contacts 114 are held in contact with mating contacts (not shown) of the smart card 112. It will be appreciated that any of a wide variety of mechanical structures other than those shown in FIGS. 1-3 may be used to contact and retain a smart card in various other embodiments of the present invention.

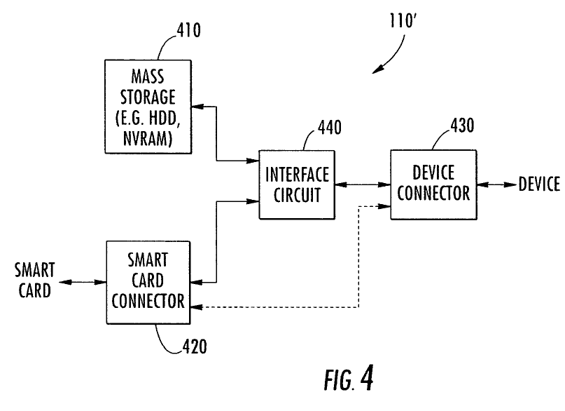

FIG. 4 illustrates an exemplary arrangement of components in a mass storage and subscriber identity module according to further embodiments of the present invention. A mass storage and subscriber identity module 110′ includes a mass storage device 410, such as a magnetic storage medium (e.g., an HDD), an optical storage medium (e.g., an optical disk drive) and/or a semiconductor storage medium (e.g., flash memory). The module 110′ further includes an interface circuit 440 that supports communication with the mass storage device 410 from a device connector 430, e.g., a connector configured to engage a mating connector in an electronic device, such as a wireless handset, PDA, laptop computer, or the like. It will be understood that the device connector may take any of a number of different forms, including, for example, a card-type connector as shown in FIGS. 1-3, or a cable-type connector, such as a Universal Serial Bus (USB) connector. The interface circuit 440 may include, for example, buffering, cache, signal processing and/or other circuitry that supports data transfer to and/or from the mass storage device 410.

A smart card connector 420, i.e., a connector configured to engage contacts on a smart card, is also electrically coupled to the device connector 430. As shown in dashed line, this connection may be direct, e.g., pins of the smart card connector 420 may be directly wired to pins of the device connector 430. Alternatively, the smart card connector 420 may be coupled to the device connector 430 via the interface circuit 440, which may, for example, provide buffering of smart card signals.

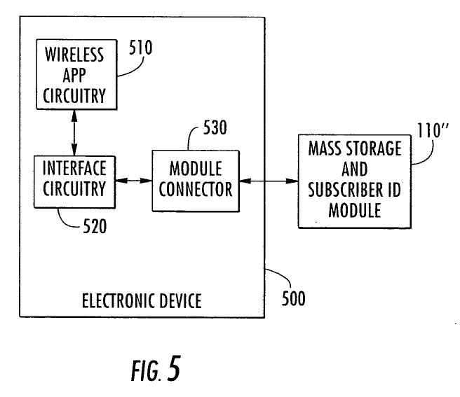

FIG. 5 illustrates an electronic device 500 configured to utilize a mass storage and subscriber identity module according to further embodiments of the present invention. As shown, the device 500, which may be, for example, a wireless handset, wireless-enabled computer or other device, includes wireless applications circuitry 510. The wireless applications circuitry 510 may include, for example, a radio transceiver, microprocessor, memory and other circuitry needed to support wireless applications for the device 500. The device 500 further includes interface circuitry 520 that is configured to communicate with the wireless applications circuitry 510 and to communicate with a removable mass storage and subscriber identity module 110″ via a module connector 530 such that, for example, data may be exchanged between the wireless applications circuitry 510 and mass storage (e.g., an HDD) in the module 110″ and subscriber identity functions may be performed by the wireless applications circuitry 510 in conjunction with complementary circuitry (e.g., a smart card) of the module 110″. Such subscriber identity functions, such as user validation and other security functions, are known to those skilled in the art, and will not be discussed in further detail.

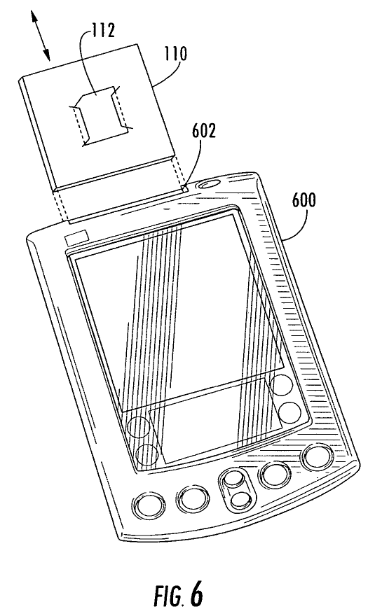

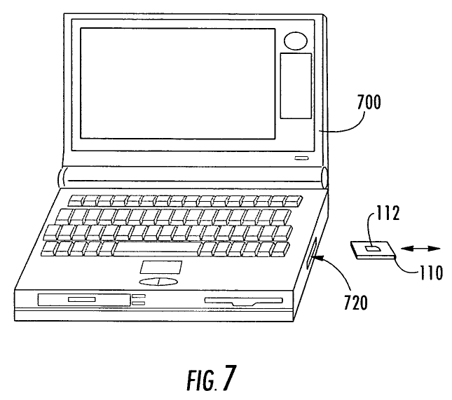

FIGS. 6 and 7, in conjunction with FIG. 1, illustrate potential advantages that may be provided by mass storage and subscriber identity modules according to some embodiments of the present invention. In particular, the mass storage and subscriber identity module 100 of FIGS. 1-3 may be compatible with a range of devices other than the wireless handset 100 shown in FIG. 1. For example, FIG. 6 shows a PDA 500 having a slot 602 configured to receive the module 110, while FIG. 7 shows a laptop computer 700 have a similar slot 702. It will be further appreciated that other compatible devices, such as gaming devices, may be similarly configured within the scope of the present invention. As will be appreciated, such arrangements enable, for example, transfer of audio and/or video files among such devices, along with subscriber identity information stored in the smart card 112 of the module 110. Thus, a user may be enabled to more easily move both personal content and service subscription between devices. This may become particularly desirable as more devices become wireless enabled.

In the drawings and specification, there have been disclosed exemplary embodiments of the invention. Although specific terms are employed, they are used in a generic and descriptive sense only and not for purposes of limitation, the scope of the invention being defined by the following claims.

That which is claimed is:

1. A mass storage and subscriber identity module comprising:
a frame;
a mass storage device supported by the frame;
a first connector supported by the frame and configured to be connected to a smart card; and
a second connector supported by the frame, electrically coupled to the mass storage device and the first connector, and configured to be removably connected to an electronic device.

2. A module according to claim 1, wherein the mass storage device comprises a magnetic storage medium, an optical storage medium and/or a semiconductor storage medium.

3. A module according to claim 1, wherein the second connector is configured to be removably connected to a subscriber identity module (SIM) card.

4. A module according to claim 1, wherein smart card contacts of the first connector are directly connected to contacts of the second connector.

5. A module according to claim 1, further comprising interface circuitry supported by the frame and configured to support communications between the first and second connectors.

6. A module according to claim 1, wherein the first connector comprises means for mechanically attaching the smart card to the frame.

7. A module according to claim 1, wherein the frame comprises a housing, wherein the mass storage device is positioned within the housing, and wherein the first connector is positioned at a surface of the housing.

8. A module according to claim 7, wherein the first connector comprises a plurality of electrical contacts positioned on the surface of the housing and a clip configured to hold the smart card against the surface of the housing such that electrical contacts of the smart card are held in contact with the electrical contacts of the first connector.

9. A module according to claim 7, wherein the housing comprises opposing first and second major sides and an edge side disposed between the first and second major sides, wherein the first connector is positioned at the first major side, and wherein the second connector is positioned at the edge side.

10. A module according to claim 9, wherein the first connector comprises a plurality of electrical contacts positioned on the first major side of the housing and a clip configured to hold the smart card against the first side of the housing such that electrical contacts of the SIM are held in contact with the electrical contacts of the first connector.

11. An apparatus comprising:
a mass storage and subscriber identity module removably connectable to an electronic device.

12. An apparatus according to claim 11, wherein the mass storage and subscriber identity module comprises a disk drive and/or a nonvolatile integrated circuit memory.

13. An apparatus according to claim 12, wherein the mass storage and subscriber identity module further comprises a smart card connector configured to be connected to a smart card.

14. An apparatus according to claim 13, wherein the smart card connector is configured to be connected to a SIM card.

15. An apparatus according to claim 13, wherein the mass storage and subscriber identity module comprises a housing that contains the disk drive, and wherein the smart card connector comprises means for removably attaching a smart card to the housing.

16. An apparatus according to claim 13, wherein the mass storage and subscriber identity module comprises a housing that contains the disk drive and/or the nonvolatile integrated circuit memory, and wherein the smart card connector comprises a plurality of contacts disposed on a side of the housing and means for holding a smart card against the side of the housing such that contacts of the smart card are held in electrical contact with the plurality of contacts disposed on the side of the housing.

17. An apparatus according to claim 11, wherein the mass storage and subscriber identity module comprises a smart card connector configured to be connected to a smart card.

18. An apparatus according to claim 17, wherein the mass storage and subscriber identity module further comprises a magnetic storage medium, an optical storage medium and/or a semiconductor storage medium.

19. An electronic device configured to be removably connected to a mass storage and subscriber identity module.

20. An apparatus according to claim 19, wherein the electronic device comprises interface circuitry configured to communicate with mass storage and a smart card of the mass storage and subscriber identity module.

21. An apparatus according to claim 19, wherein the electronic device comprises a connector configured to removably connect the mass storage and subscriber identity module to the electronic device.

22. An apparatus according to claim 19, wherein the electronic device comprises a housing and means for removably attaching the mass storage and subscriber identity module to the housing.

23. An apparatus according to claim 22, wherein the means for removably attaching comprises a bay or slot configured to receive a housing of the mass storage and subscriber identity module.
